(19) United States
(12) Patent Application Publication
(10) Pub. No.: US 2007/0245781 A1
(43) Pub. Date: Oct. 25, 2007

(54) Bolt Design

(76) Inventor: Shmulik Landau, Mazceret Batia (IL)

Correspondence Address: FLEIT KAIN GIBBONS GUTMAN BONGINI & BIANCO, 21355 EAST DIXIE HIGHWAY, SUITE 115, MIAMI, FL, 33180, US

(21) Appl. No.: 11/572,846

(22) PCT Filed: Aug. 9, 2005
(86) PCT No.: PCT/IL05/00858

§ 371 Date: Jan. 29, 2007

(30) Foreign Application Priority Data
Aug. 9, 2004 (IL) 163412

(51) Int. Cl. E05B 65/06

(52) U.S. Cl. 70/103

(57) ABSTRACT

A lock for locking a door into a doorpost, including a lock casing for insertion into a door, a keyhole in the casing for turning a key and locking the lock, and at least one bolt operatively connected to the casing and to the keyhole that slides out and protrudes from the casing when the lock is locked, for insertion into a corresponding mortise in a doorpost, wherein each bolt has at least one angular, wedge-shaped indentation cut into its surface, the wedge-shaped indentations facing the inside of the door and being inclined away from the doorpost, for engaging the bolts on the planar edges of the mortises in the doorpost when pressure is applied to the lock from outside of the door.

### BACKGROUND OF THE INVENTION

The present invention relates to an improved bolt design, for preventing break-ins.

The best deterrent to break-ins is a locked door. But the security provided by the locked door is only as good as the construction of the lock, and its ability to prevent the thief from forcing entry through impact or by means of prying the lock open. Most locks offer some protection against prying and jimmying. The latch type lock presented in UK Patent Application GB2358429A provides a method for preventing the lock latch from being moved by the insertion of a flexible sheet between the door and the doorpost. However, the latch of this type of lock does not typically extend far enough into the doorframe to resist the leverage applied by a strong force.

Many homes, shops, and offices around the world have doors are more effectively protected with strong, mortise, rim, or deadbolt type locks in order to prevent break-ins. Despite such precautions, thieves are able to gain entry by using large crowbars to pry open locked doors by wedging the thin end of the crowbar between the door and the doorpost. Using the leverage of the crowbar, strong force is applied to the bolts of the lock, causing the bolts to bend to such an extent that they slip out of the corresponding mortises in the doorpost, and release the lock.

### SUMMARY OF INVENTION

The present invention provides an improved lock that is much more difficult to break than conventional locks such as a mortise, rim, or deadbolt type locks. The present invention uses wedge-shaped indentations cut into the bolts of the lock to prevent the bolts from slipping under force. When a force is applied to the lock, the bolts catch in the planar edge of the mortise on the doorpost and remain engaged, even as additional force is applied.

There is thus provided in accordance with a preferred embodiment of the present invention a lock for locking a door into a doorpost, including a casing for a lock, for insertion into a door, a keyhole in said casing for turning a key and locking the lock, and at least one bolt operatively connected to said casing and to said keyhole that slides out and protrudes from the casing when the lock is locked, for insertion into corresponding mortises in a doorpost, wherein each of the bolts has at least one wedge-shaped indentation cut into its surface, the indentation facing the inside of the door and being inclined away from the doorpost, for engaging the bolts in the doorpost mortises when pressure is applied to the lock from outside of the door.

There is additionally provided in accordance with a preferred embodiment of the present invention a lock for locking a safe, including a casing for a lock, for insertion into a safe door, a keyhole in said casing for turning a key and locking the safe, and at least one bolt operatively connected to said casing and to said keyhole that slides out and protrudes from the casing when the lock is locked, wherein each of the bolts has at least one wedge-shaped indentation cut into its surface, the indentation facing the inside of the safe door, for engaging the bolts in the safe mortises when pressure is applied to the lock from outside of the safe door.

There is further provided in accordance with a preferred embodiment of the present invention an enhanced locking device for doors to prevent the lock from opening when force is applied from outside the door, said device including a doorpost having at least one mortise, a casing for a lock, located within a door, a keyhole in said casing for turning a key and locking the lock, and at least one bolt operatively connected to said casing and to said keyhole that slides out and protrudes from the casing when the lock is locked, for insertion into corresponding mortises in the doorpost, wherein each of the bolts has at least one wedge-shaped indentation cut into its surface, the indentation facing the inside of the door and being inclined away from the doorpost, for engaging the bolts in the doorpost mortises when pressure is applied to the lock from outside of the door.

There is yet further provided in accordance with a preferred embodiment of the present invention a device wherein the doorpost mortises are shaped to correspond to the bolts.

There is also provided in accordance with a preferred embodiment of the present invention a device wherein the doorpost mortises include a planar edge located to correspond to the indentations on the bolts.

### BRIEF DESCRIPTION OF DRAWINGS

The present invention will be more fully understood and appreciated from the following detailed description, taken in conjunction with the drawing, in which:

FIG. 1 is a perspective view of an exemplary embodiment of the present invention.

FIG. 2 is a perspective view of the same embodiment of the present invention, wherein the lock is engaged.

FIG. 3 is an end view of the same.

FIG. 4 is an end view of a bolt seated in a mortise of the same embodiment.

FIG. 5 is a cross-sectional view of the same embodiment, wherein the lock is engaged.

FIG. 6 is a cross-sectional view of the same embodiment, wherein the indentation on the bolt is engaged by the planar edge of the mortise.

### DESCRIPTION OF THE PREFERRED EMBODIMENT

A prior art lock of the mortise type typically has three bolts that slide to protrude out of the casing when the lock is locked. Specifically a key is inserted into a keyhole and, when the key is turned in one direction (usually clockwise), the bolts slide out so as to protrude outside of the lock, and the lock is locked. When the key is turned in the other direction to unlock the door, the bolts slide back inside of the lock casing. The lock is positioned on a door and, corresponding to the location of the bolts, mortises shaped to generally correspond with the shape of the bolts are bored into a doorpost. Thus, when the lock is locked, its bolts slide out and insert themselves into the corresponding mortises in the doorpost.

Such locks are vulnerable to break-in. Specifically, thieves from the outside can pry a crowbar into the thin space between the door and the doorpost, and use the leverage of the crowbar to apply extreme force to the lock. Under this force, the bolts bend to such an extent that they slip from the mortises in the doorpost, at which point the door is no longer locked.

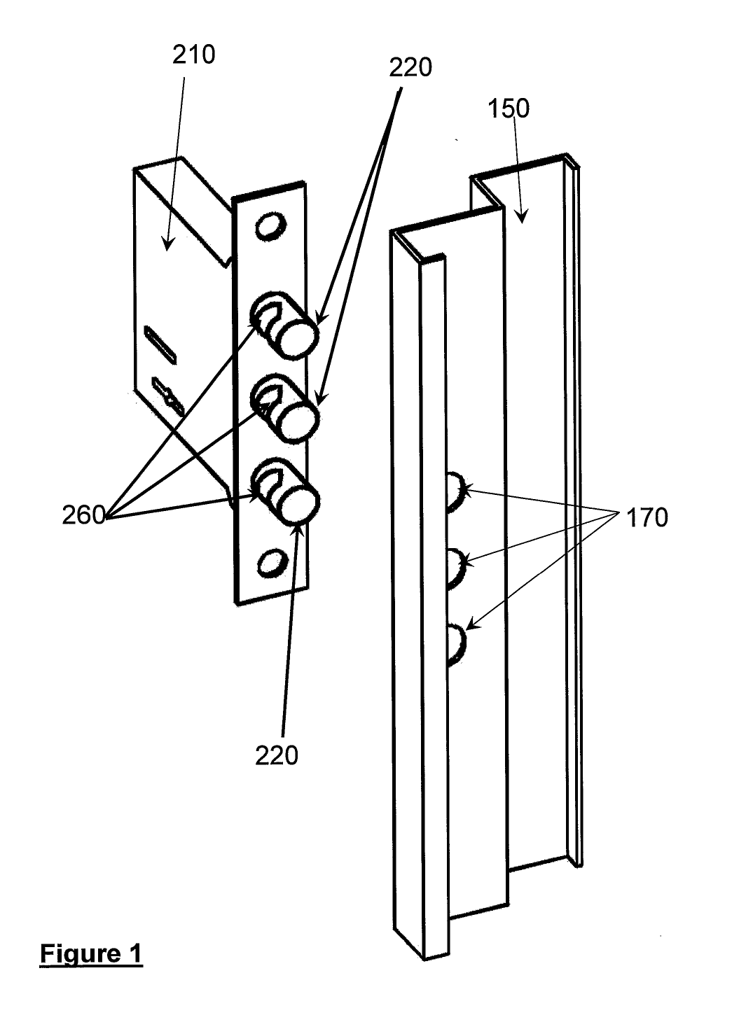

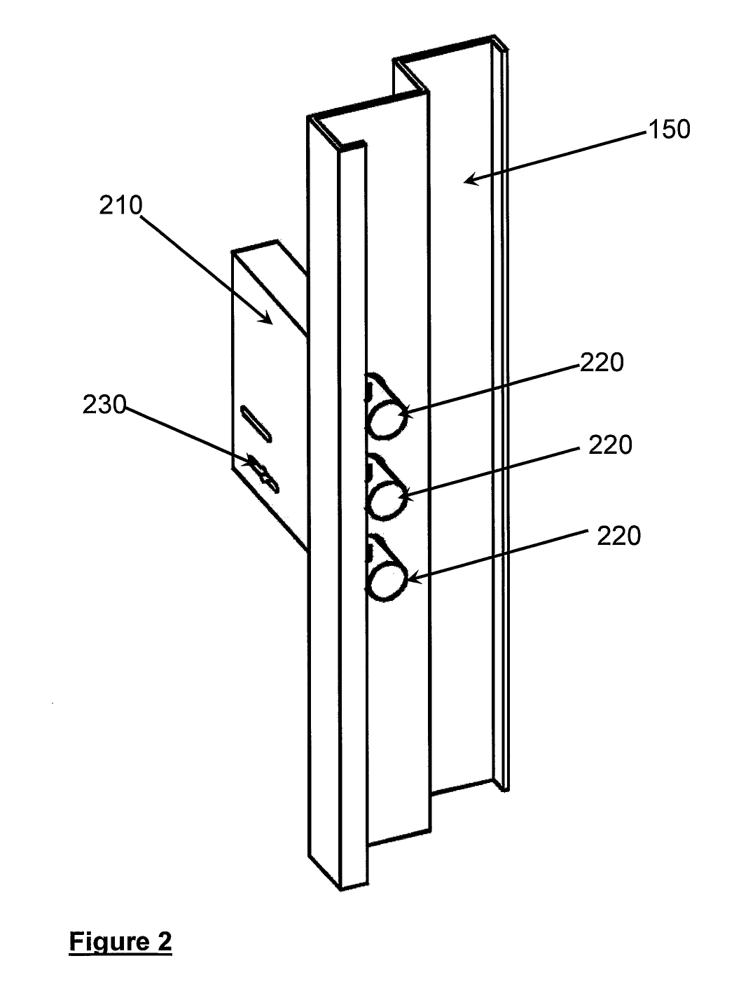

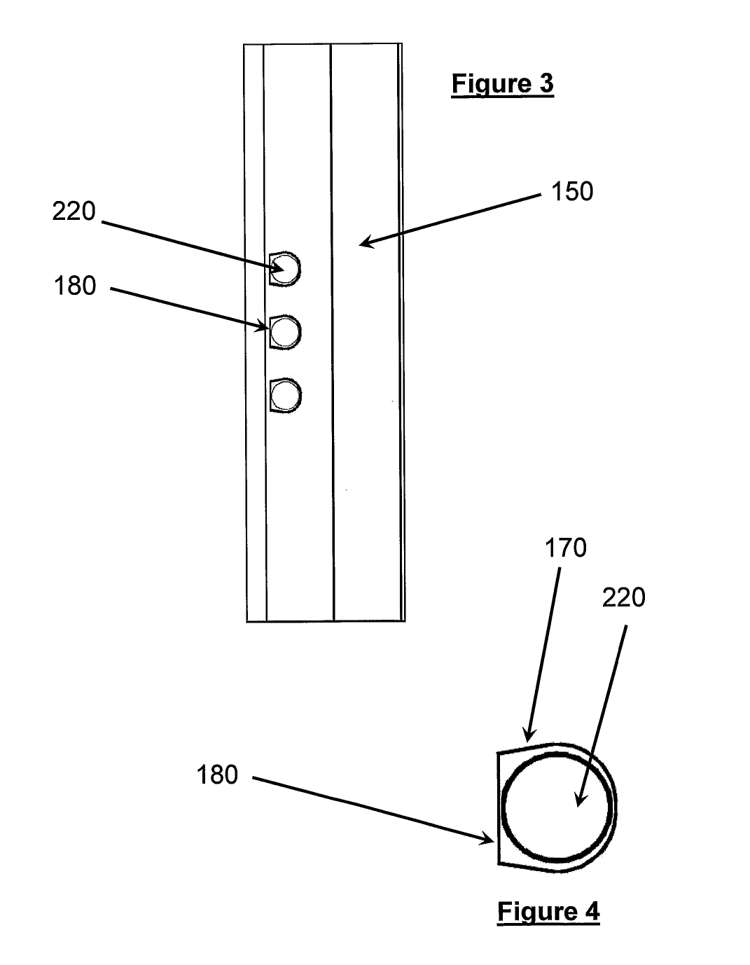

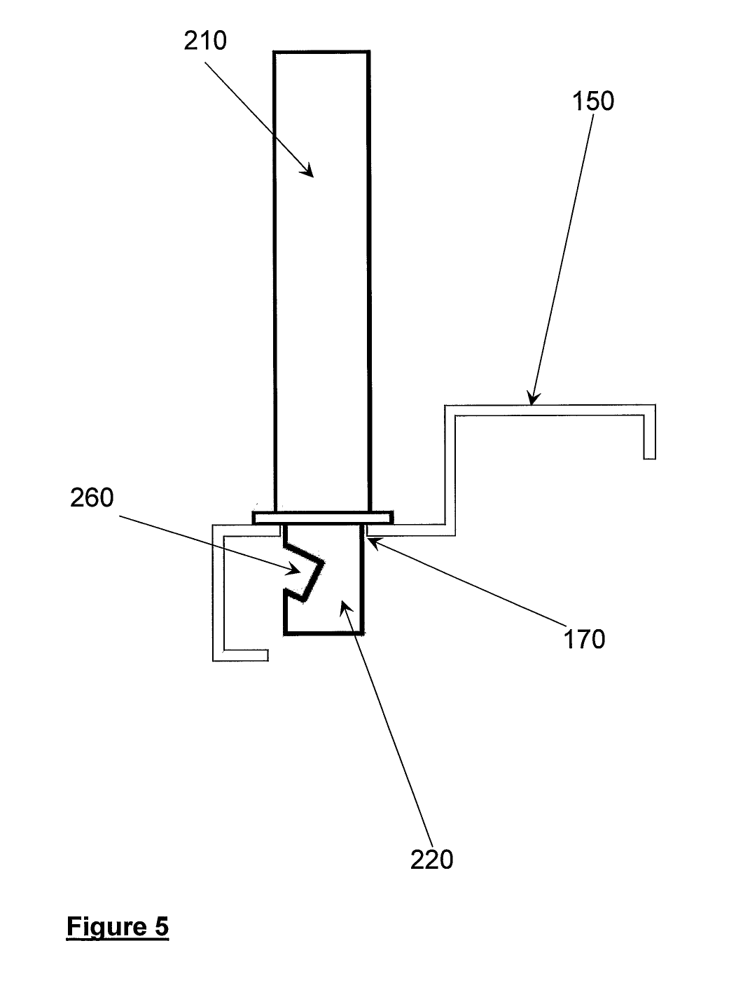

Reference is now made to FIGS. 1 through 6, which are diagrams of an improved lock 210, the bolts 220 of which catch on the planar edges 180 of mortises 170 of doorpost 150 and remain engaged by said planar edges 180 when a force is applied, in accordance with an exemplary embodiment of the present invention. Shown in FIGS. 1, 2, 3, and 5 is a modified lock 210 with angular, wedge-shaped indentations 260 cut into bolts 220. Lock 210 operates similar to the prior art lock described above, with bolts 220 that slide out when a key is inserted into keyhole 230 and turned. When the key is turned, bolts 220 slide out of lock 210 and insert themselves into corresponding mortises 170 in doorpost 150. As seen in FIG. 4, an important modification has also been made to mortise 170, wherein mortise 170 includes a planar edge 180 that corresponds to indentation 260 of bolt 220.

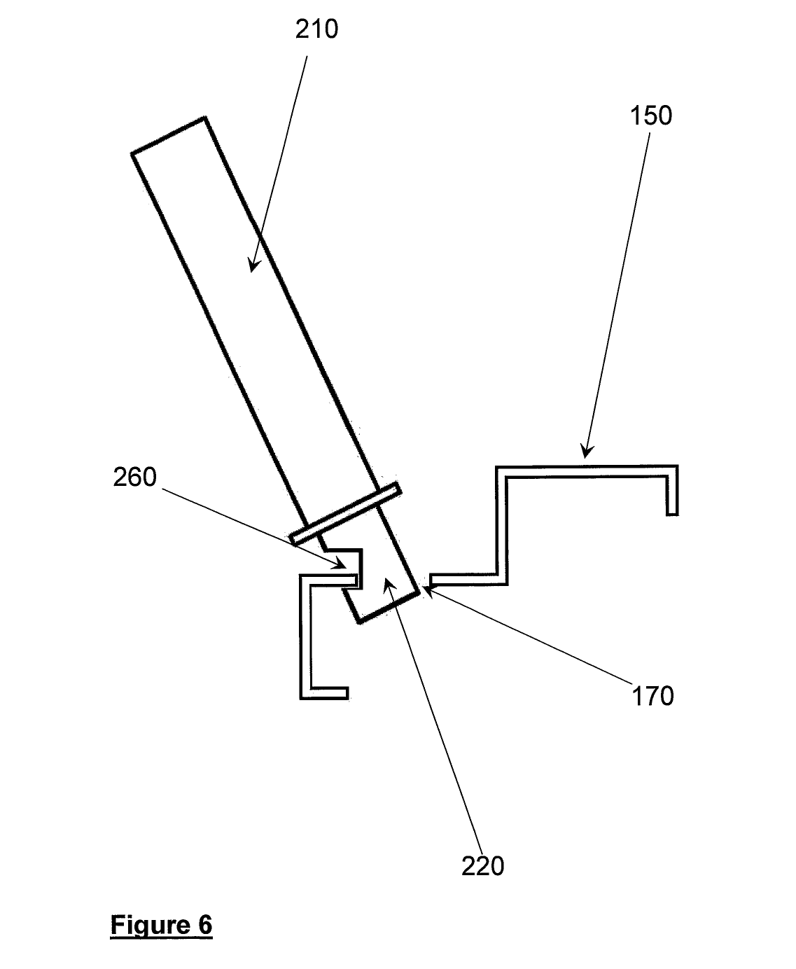

Therefore, because of the presence of angular, wedge-shaped indentations 260 and the specially shaped mortises 170, when force is applied to lock 210, rather than slip, bolts 220 catch on the planar edges 180 of mortises 170 and engage doorpost 150, thus preventing the bolts from releasing. This is clearly demonstrated in FIG. 6. Specifically, angular, wedge-shaped indentations 260 are inclined away from doorpost 150 so that the bolts latch onto the planar edges 180 of mortises 170 of doorpost 150 and do not slip out.

In accordance with the present invention, one or more angular, wedge-shaped indentations 260 may be cut into bolts 220. Additional wedge-shaped indentations 260 provide added protection. In case lock 210 slips from the first wedge-shaped indentation 260, a next wedge-shaped indentation 260 may catch and engage on the planar edge 180 of mortise 170 in doorpost 150.

It may thus be appreciated that lock 210 provides greater protection than the prior art lock described above, and is less vulnerable to break-in.

The present invention has wide spread application to various types of locks, including inter alia upper door locks, such as mortise, rim, or deadbolt type locks, and locks for safes.

In reading the above description, persons skilled in the art will realize that there are many apparent variations that can be applied to lock 210 described herein. Thus, although FIGS. 1 through 6 are oriented so that the door is on the left of a person inside of a house, the present invention also applies to doors that are oriented on the right of a person inside of a house. Similarly, although FIGS. 1, 2, and 3 illustrate three bolts 220 protruding from lock 210, the present invention applies to any number of bolts 220. Moreover, it is not necessary for each bolt 220 to have a wedge-shaped indentation 260. The present invention applies even if not all of bolts 220 have wedge-shaped indentations 260, although it may be appreciated that maximum protection is obtained when all of bolts 220 are thusly indented.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed is:

1. A lock for locking a door into a doorpost, comprising:
a casing for a lock, for insertion into a door;
a keyhole in said casing for turning a key and locking the lock; and
at least one bolt operatively connected to said casing and to said keyhole that slides out and protrudes from the casing when the lock is locked, for insertion into corresponding mortises in a doorpost, wherein each of the bolts has at least one wedge-shaped indentation cut into its surface, the indentation facing the inside of the door and being inclined away from the doorpost, for engaging the bolts in the doorpost mortises when pressure is applied to the lock from outside of the door.

2. A lock for locking a safe, comprising;
a casing for a lock, for insertion into a safe door;
a keyhole in said casing for turning a key and locking the safe; and
at least one bolt operatively connected to said casing and to said keyhole that slides out and protrudes from the casing when the lock is locked, wherein each of the bolts has at least one wedge-shaped indentation cut into its surface, the indentation facing the inside of the safe door, for engaging the bolts in the safe mortises when pressure is applied to the lock from outside of the safe door.

3. An enhanced locking device for doors to prevent the lock from opening when force is applied from outside the door, said device comprising:
a doorpost having at least one mortise;
a casing for a lock, located within a door;
a keyhole in said casing for turning a key and locking the lock; and
at least one bolt operatively connected to said casing and to said keyhole that slides out and protrudes from the casing when the lock is locked, for insertion into corresponding mortises in the doorpost, wherein each of the bolts has at least one wedge-shaped indentation cut into its surface, the indentation facing the inside of the door and being inclined away from the doorpost, for engaging the bolts in the doorpost mortises when pressure is applied to the lock from outside of the door.

4. The device of claim 3 wherein the doorpost mortises are shaped to correspond to the bolts.

5. The device of claim 3 wherein the doorpost mortises include a planar edge located to correspond to the indentations on the bolts.
